(19) United States
(12) Patent Application Publication
(10) Pub. No.: US 2008/0189435 A1
(43) Pub. Date: Aug. 7, 2008

(54) INTRA-NETWORK SWITCHING

(75) Inventors: Rashad Mohammad Ali, Plano, TX (US); Mahbubul Alam, McKinney, TX (US); Pulin R. Patel, McKinney, TX (US)

Correspondence Address: FISH & RICHARDSON P.C., P.O. BOX 1022, MINNEAPOLIS, MN, 55440-1022, US

(73) Assignee: MAVENIR SYSTEMS, INC., Richardson, TX (US)

(21) Appl. No.: 11/672,443

(22) Filed: Feb. 7, 2007

(51) Int. Cl. G06F 15/173

(52) U.S. Cl. 709/242; 709/238

(57) ABSTRACT

This disclosure provides a system and method for intra-network switching. In some embodiments, a method includes receiving a communication in an Internet Protocol network. The communication is based, at least in part, on a cellular radio technology associated with a mobile switching center. The communication is routed to a network element independent of the mobile switching center.

### TECHNICAL FIELD

This invention relates to networks and, more particularly, to intra-network switching.

### BACKGROUND

Communications networks include wired and wireless networks. Example wired networks include the Public Switched Telephone Network (PSTN) and the Internet. Example wireless networks include cellular networks as well as unlicensed wireless networks that connect to wire networks. Calls and other communications may be connected across wired and wireless networks.

Cellular networks are radio networks made up of a number of radio cells, or cells, that are each served by a base station or other fixed transceiver. The cells are used to cover different areas in order to provide radio coverage over a wide area. When a cell phone moves from place to place, it is handed off from cell to cell to maintain a connection. The handoff mechanism differs depending on the type of cellular network. Example cellular networks include Universal Mobile Telecommunications System (UMTS), Wide-band Code Division Multiple Access (WCDMA), and CDMA2000. Cellular networks communication in a radio frequency band licensed and controlled by the government.

Unlicensed wireless networks are typically used to wirelessly connect portable computers, PDAs and other computing devices to the internet or other wired network. These wireless networks include one or more access points that may communicate with computing devices using an 802.11 and other similar technologies.

### SUMMARY

This disclosure provides a system and method for intra-network switching. In some embodiments, a method includes receiving a communication in an Internet Protocol network. The communication is based, at least in part, on a cellular radio technology associated with a mobile switching center. The communication is routed to a network element independent of the mobile switching center.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram illustrating a communication system in accordance with one embodiment of the present disclosure;

FIG. 2 is a block diagram illustrating signal paths in communication system of FIG. 1 in accordance with on embodiment of the present disclosure;

FIGS. 3A and 3B illustrate an example routing table and connection table, respectively, in communication system of FIG. 1 in accordance with one embodiment of the present disclosure;

FIG. 4 is a block diagram illustrating mobility of a mobile device in communication system of FIG. 1 in accordance with one embodiment of the present disclosure;

FIGS 5-7 are flow diagrams illustrating example methods for updating routing tables in communication system of FIG. 1 in accordance with one embodiment of the present disclosure; and

FIG. 8 is a flow diagram illustrating an example method for providing intra-network switching in accordance with one embodiment of the present disclosure.

Like reference symbols in the various drawings indicate like elements.

### DETAILED DESCRIPTION

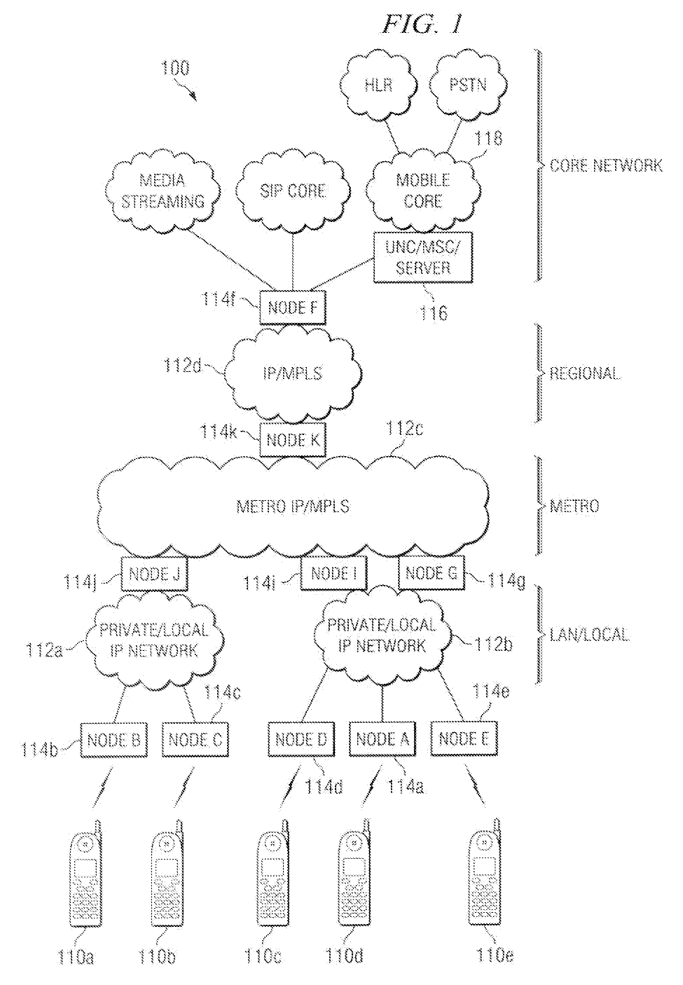

FIG. 1 illustrates a communication system 100 for providing intra-network switching for media devices 110. For example, system 100 may identify location information associated with mobile devices 110 using cellular radio technologies and switch signals directly between devices 110 using the location information. Cellular radio technologies may include Global System for Mobile Communication (GSM) protocols, Code Division Multiple Access (CDMA) protocols, Universal Mobile Telecommunications System (UMTS), Session Initiation Protocol (SIP), Unlicensed Mobile Access (UMA), MAC/RLC/PDCP, RTSP, EAP-SIM, IKEv2, and/or any other suitable protocol for formatting data for wireless communication. In some embodiments, system 100 represents devices 110 as mobile devices to a core network 118. As a result, system 100 may identify locations of these devices 110 using cellular radio technologies and switch communications between devices 110 independent of core network 118 using nodes 114. For example, UMA Network Controller (UNC) 116 may identify devices 110 as mobile devices and, thus, store location information associated with each device 110. In doing so, system 100 may use this location information to direct traffic between devices 110 independent of UNC 116. In other words, system 100 may use the information provided by the cellular radio technologies to enable nodes 114 to provide intra-network switching between devices 110. As a result, communications between devices 110 may be routed directly without transmitting the message to the UNC 116 and, thus, minimize, reduce, or eliminate some network traffic in network 112.

At a high level, system 100 includes mobile devices 110a-c, nodes 114, and UNC 116. Each mobile device 110a-c comprises an electronic device operable to receive and transmit wireless communication with system 100. As used in this disclosure, mobile devices 110 are intended to encompass cellular phones, data phones, pagers, portable computers, smart phones, personal data assistants (PDAs), one or more processors within these or other devices, or any other suitable processing devices capable of communicating information over a wireless link to at least some of node 114, such as nodes 114a-e. Mobile devices 110a-c may use cellular radio technology and/or unlicensed radio technology to transmit and/or receive signals from nodes 114a-e. The mobile devices 110a-c may transmit voice, video, multimedia, text, web content or any other user/client-specific content. In short, device 110 generates requests, responses or otherwise communicates with other devices 110 via network 112.

In the illustrated embodiment, mobile devices 110 use UMTS to transmit signals to and/or receive signals from nodes 114a-e. for this and other embodiments, mobile devices 110 may operate in a licensed band and/or operate in an unlicensed band with example, mobile devices 100 may wirelessly communicate in an unlicensed band with nodes 114a-e and may wirelessly communicate in a licensed band with a base station or other cellular network element. For communication in the unlicensed band, the UMTS or other cellular radio technologies may be adapted to meet the regulatory requirements for transmitting in the unlicensed band. For example, UMTS signaling may be limited to a maximum power output, a power spectral density limits, and/or otherwise adapted. It will be understood that there may be any number of mobile devices 110 communicably coupled to nodes 114a-e.

Nodes 114a-e may perform two functions: providing an access point for devices 110 and providing intra-network switching. As for access point operation, nodes 114a-e can include any software, hardware, and/or firmware operable to receive messages transmitted using cellular radio technologies and/or unlicensed radio technologies. In addition, nodes 114a-c may generate IP packets (e.g., UMA packets) based, at least in part, on received cellular radio technology and/or unlicensed radio technology messages. In some embodiments, nodes 114a-c convert one or more parameters from a first cellular radio technology, such as UMTS, to a second cellular radio technology, such as GSM. After converting the UMTS parameter to GSM parameters, nodes 114a-e may generate UMA packets for tunneling the GSM parameters through IP network 112 to UNC 116. Nodes 114a-e may also encapsulate mobility and Quality of Service (QoS) parameters in the UMA packets using an extension or other suitable methods for tunneling such parameters through IP network 112 to UNC 116. In tunneling GSM parameters through IP network 112, nodes 114a-e may perform two functions when generating the associated IP packet: (1) translating parameters of UMTS to associated GSM parameters; and (2) encapsulating parameters not supported by UMA. In regards to encapsulations, nodes 114a-e, as mentioned above, may encapsulate cellular radio technology parameters in an extension of an IP packet such as a UMA packet. For example, nodes 114a-e may add a soft handoff parameter/message to a standard UMA message with appropriate headers and, thus, form a UMA++ message.

Turning to translations, nodes 114a-e may translate, map, or otherwise covert parameters between two different cellular radio technologies. For example, nodes 114a-e may convert a call setup message from UMTS to a call setup message complying with UMA/GSM or SIP. In addition, nodes 114a-e may translate or otherwise map the cellular-radio-technology parameters to one or more parameters of a different cellular radio technology. In particular, nodes 114a-e may unencapsulate cellular radio technology parameters from an IP packet such as a UMA packet and convert these parameters to a different radio technology parameter. After nodes 114a-e map parameters between the different cellular radio technologies, nodes 114a-e may generate a wireless message based, at least in part, on the translated parameters and wirelessly transmits the message received from IP network 112 to the associated mobile device 110. In some embodiments, nodes 114a-e use IP security (IPsec) to tunnel messages through network 112. For example, multiple security association may be made per IPsec tunnel such as one for control signaling, one multiple for upstream, and one multiple for downstream.

Now turning to the intra-network switching, nodes 114, including nodes 114a-e, may provide switching within different hierarchies of network 112 and, thus, may reduce or minimize network traffic. Network 112 facilitates wireline and/or wireless communication between nodes 114, mobile devices 110, and/or any other device. As described, network 112 communicates IP packets to transfer voice, video, data, and other suitable information between network addresses. Network 114 may include one or more local area networks (LANs), metropolitan area networks (MANs), regional area networks (RANs), wide area networks (WANs), all or a portion of the global computer network known as the Internet, and/or any other communication system or systems at one or more locations. In the illustrated embodiment, network 112 includes multiple hierarchies of networks including LANs 112a and 112b, MAN 112c, and RAN 112d. LANs are a communication network that typically connect computers, workstations, printers, servers, and other devices within a relatively small geographic area (e.g., Ethernet). A LAN is typically confined to a building or a campus. In the illustrated embodiment, LANs 112a and 112b are communicably coupled to the larger communication network MAN 112c through nodes 114j and 114i, respectively. A MAN is typically; an intra-city network that connects multiple locations within, for example, a campus or city and may span 100 kilometers (km) in diameter. MAN 112c is communicably coupled to the larger communication network RAN 112d via node 114k. A RAN is typically a communication network that interconnects businesses, residences, and governments within a specific region that often spans multiple urban areas. RAN 112c is communicably coupled to core network 118 through node 114f. Each node 114 between the different hierarchies of network 112 may provide intra-network switching.

Node 114 can include any software, hardware, and/or firmware operable to switch, route, or other wise direct ingress and egress IP messages. To facilitate switching of traffic, node 114 may represent devices 110 as mobile devices such as UMA devices to UMC 116. By doing so, core network 118 may maintain location information associated with devices 110. Node 114 may use this location information to switch IP messages between mobile devices 110 independent of UNC 116. For example, node 114 may identify the location of a mobile device 110 based, at least in part, on a message including cellular radio technology. Once node 114 determines the location of device 110, node 114 may update their routing tables to enable intra-network switching independent of UNC 116. For example, node 114 may receive a message that includes information identifying nodes 114 that the message was previously routed through. Using this path information, nodes 114 may update an associated routing table. For instance, node 114e may receive a message indicated that the message transmitted by device 110c passed through node 114d. As a result, node 114e may transmit a response to device 110c directly to node 114d independent of UNC 116 and, thus, provide intra-network switching within LAN 112b. In some embodiments, nodes 114 amend received messages with information indicating that the message was routed through that node 114. In doing so, nodes 114 may provide location information to nodes 114 along the message's path, which may enable intra-network switching at one or more of the network hierarchies. For instance, node 114k may receive a message indicating that the message went from node 114b to node 114j. In this case, node 114k may add information that the message also passed through node 114k before forwarding the message to node 114f.

In summary, nodes 114 may receive a message, identify a location of the destination device 110 using the associated cellular radio technology, and switch, route, or otherwise direct the message to the destination device 110 independent of UNC 116. Node 114 may identify the destination by realizing the address of the termination device 110 or, for example, being provisioned to switch traffic received from a particular device, port, or session to another device, port or session. In addition, node 114 may be IPsec compliant such that messages received from other nodes 114 may be decrypted or messages transmitted to other nodes 114 may be encrypted. In some embodiments, node 114 decrypts a received message to identify information necessary to route the message accordingly. In this case, node 114 may receive a UMA message form node 114a and decrypt the IPsec portion of the message. After identifying that the message is destined for device 110d coupled to node 114e, node 114a may encrypt the message and transmit the message directly to the node 114e for routing to device 110d.

Node 114f may, in some embodiments, represent itself as a base station controller (BSC) to UNC 116. Thus, node 114f may be queried by UNC 116 in core network 118 like any other BSC, and UNC 116 may be unaware of the different access mechanisms being supported by node 114f compared to an actual base station controller. In a particular embodiment, node 114f may include a database, or access to a database, of devices 110 or other suitable endpoints or other devices to which may establish a communication session and/or forward voice or other media. In some embodiments, node 114f may have an A+/IuCS+ or an A interface, as defined in the GSM/UMTS specifications 24.008/04.08/08.08, to UNC 116.

UNC 116 can include any software, hardware, and/or firmware operable to manage UMA devices. As discussed above, nodes 114a-e may convert messages generated by the devices 110 to UMA messages or SIP messages. Accordingly, devices 110 appear as UMA devices to UNC 116. As a result, UNC 116 is operable to manage devices 110. For example, UNC 116 may perform registration for UMA control services, set up or tear down bearer paths, terminate secure remote access tunnels from enterprise devices, and other suitable services. In addition, UNC 116 may provide location information for devices 110. In general, UNC 116 monitors devices 110 via nodes 114. For example, UNC 116 may store the identity, location, and/or capabilities of devices 110 during registration. UNC 116 may require such information to provide support services and/or potentially handover functionality for devices 110. After registration is approved by UNC 116, the current location information is updated in core network 118, and from that point on, in some embodiments, voice and data traffic may be routed to devices 110 via nodes 114 rather than a radio access network associated with core network 118. In some embodiments, both roaming and handover is transparent to a user of devices 110.

Core network 118 typically includes various switching elements and gateways for enabling communication via a number of RANs, and also interfaces the cellular system with other communication systems such as IP network 112 via UNC 116 and MSC (include in UNC 116). In accordance with the GSM standard, core network 118 includes a circuit switched (or voice switching) portion for processing voice calls and a packet switched (or data switching) portion for supporting data transfers such as, for example, e-mail messages and web browsing. The circuit switched portion includes MSC that switches or connects telephone calls between RANs and IP network 112. The packet-switched portions, also known as General Packet Radio Service (GPRS), includes a Serving GPRS Support Node (SGSN) (not illustrated), similar to MSC, for serving and tracking mobile devices, and a Gateway GPRS Support Node (GGSN) (not illustrated) for establishing connections between packet-switched networks and mobile devices. The SGSN may also contain subscriber data useful for establishing and handing over call connections. Core network 118 may also include a home location register (HLR) for maintaining “permanent” subscriber data and a visitor location register (VLR) (and/or a SGSN) for “temporarily” maintaining in subscriber data retrieved from the HLR and up-to-date information on the location of the mobile station. In addition, core network 118 may include Authentication, Authorization, and Accounting (AAA) that performs the role of authenticating, authorizing, and accounting for devices operable to access core network 118. In short, core network 118 is operable to transmit and receive wireless message via RANs.

In one aspect of operation, device 110d wirelessly transmit to node 114a an initial UMTS message destined for device 110c. After receiving the message, node 114a translate UMTS parameters to associated GSM parameters and generates a UMA message based, at least in part, on the GSM parameters. For GSM parameters not supported by UMA, node 114a may encapsulate such parameters in an extension to the UMA message. For example, node 114a may include GSM parameters associated with mobility and QoS of device 110d in an extension to the UMA message. In addition, node 114a may secure the transmission of the UMA message through IP network 112 by using IPsec to tunnel GSM portions of the UMA message. In some embodiments, node 114a modifies the message to include information indicating that the message was routed through node 114a. Node 114a transmits the UMA message through IP network 112 to node 114i. Node 114i decrypts the UMA message and identifies information associated with a destination of the UMA message. In some embodiments, node 114i modifies the message to include information indicating that the message was routed from node 114a to node 114i. Afterwards, node 114i encrypts the UMA message prior to routing the UMA message to the appropriate network element. Analogous processes may be performed at nodes 114k, and 114f, and node 114i-f pass the UMA message to UNC 116. In some embodiments, nodes 114i, 114k, and 114f modify the message to include information indicating that the path of the message is from node 114a to 114i to 114k to 114f.

As the message is routed from UNC 116 to mobile device 110c, nodes 114k, 114i, and node 114d add path information to the message indicating the rout of the message through network 112. In addition, these nodes 114 identify the path information for determining whether associated routing tables may be updated. For example, node 114d may identify the path information and determine that the message was routed through node 114a based, at least in part, on the path information. In response to at least determining that the message passed through a different node 114 in the same network hierarchy, node 114d may update the associated routing table indicating that messages destined for device 110d be routed directly to node 114a. Similarly, node 114d may transmit a response to the message directly to node 114a for device 110d. In this case, node 114a may identify the path information and update an associated routing table indicating that messages destined for device 110c be routed directly to node 114c.

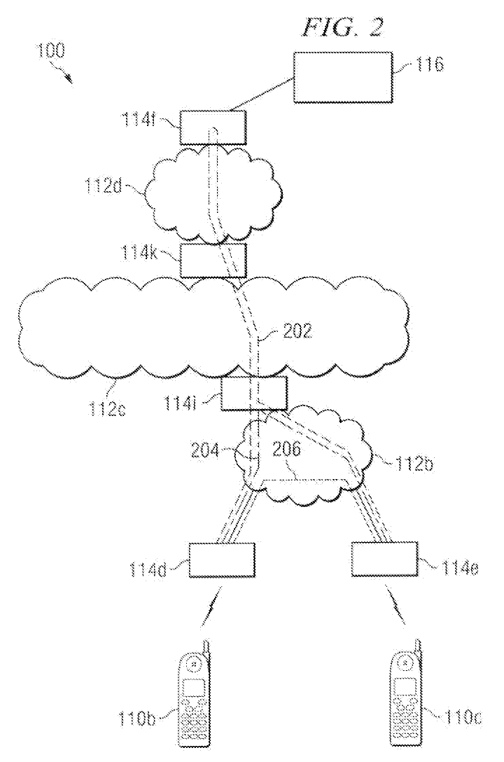

FIG. 2 is a block diagram illustrating example signal paths between node D and node E of FIG. 1 for providing intra-network switching in accordance with one embodiment of the present disclosure. For case of reference, only some of the elements of communication system 100 of FIG. 1 are shown. In the illustrated embodiment, three signal streams are shown between node 114d and node 114e. Signal stream 202 originates at either node 114d or node 114e and is destined for the other node via node 114i. Signal stream 204 originates at either node 114d or node 114e and is destined for the other node 114 via node 114i. Signal stream 206 originates at either node 114d or node 114e and is routed directly to the other node 114. Signal streams 202, 204, and 206 are illustrated between node 114d and node 114e to illustrate that the number of hops between two nodes 114 may be reduced or minimized, and, as a result, traffic in network 112 may be reduced, eliminated, or minimized.

In one aspect of operation, mobile device 110b wirelessly transmits to node 114d a request to initiate a call with mobile device 110c. In some embodiments, node 114d receives a UMTS message and generates a UMA message based, at least in part, on the UMTS message. IN the event that node 114d does not contain information identifying the location of mobile device 110c, node 114d forwards the signal to node 110i. In some embodiments, node 114d also transmits information identifying the path of the signal. For example, node 114d may also transmit a tag, a label, and/or an address with the signal that indicates to the next node 114i that the signal was transmitted from node 114d. In the event that node 114i does not contain information identifying the location of mobile device 110c, node 114i, by default, may forward the signal indicating that signal was transmitted through both node 114d and 114i. Similar processes may be performed by node 114k. Node 114k forwards the signal to UNC 116 in the event that node 114k does not include location information for mobile device 110c. UNC 116 identifies the location of mobile device 110c and directs the signal to node 114i via node 114k, which then directs the signal to node 114e. As suggested above, each node 114 may add information the signal indicating that the signal passed through that node 114. In doing so, when the signal arrives at node 114e, the signal may include information that the signal traveled from node 114d to 114i to 114k to 114f to node 114k to 114i to 114e. This information may be used to update connection tables and/or routing tables at each node 114. For example, node 114e may update an associated routing table based, at least in part, on the path information and route traffic destined for mobile device 110b to node 114d. When node 114 is processing and/or optimizing the route for a signal, node 114 may rely on the path information to determine the next node 114. For example, node 114e may determine a route between mobile device 110b and 110c based, at least in part, on the path information. Alternatively or in combination, node 114e may determine the route based, at least in part, on hop counts. In the illustrated embodiments, node 114e may process signal stream 204 and signal stream 206 when determining the path between mobile device 110c and mobile device 110b.

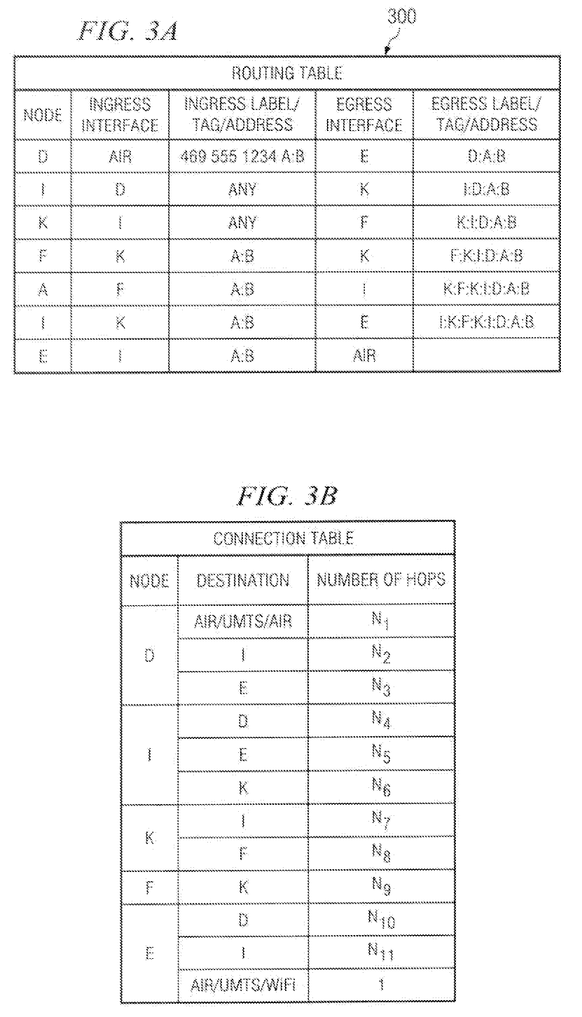

FIGS. 3A and 3B illustrate a routing table 300 and a connection table 350 for providing intra-network switching in accordance with one embodiment of the present disclosure. Routing table 300 and connection table 350 are described with respect to system 100 of FIG. 2, but routing table 300 and connection table 350 could be used by any other system. Moreover, system 100 may use any other suitable tables and/or techniques for providing intra-networking switching. System 100 may also use tables with additional path information, less path information, and/or different path information, so long as the routing proves intra-network switching.

Referring to FIG. 3A, routing table 300 includes information associated with routing messages between mobile device 110b and 110c. Routing table 300 is arranged with five columns and eight rows whose intersection forms a cell. Each cell contains information associated with a node 114 and/or routing performed by that node. In the illustrated embodiment, routing table 300 includes the following five columns: node, ingress interface, ingress label/tag/address, egress interface, and egress label/tag/address. Routing table 300 includes the following eight rows: Node, D, I, K, F, K, I and E. In other words, each row labeled with a letter indicates the associated node 114. For example, row labeled D is associated with node 114d. Each cell in a row contains information associated with node 114 such as node 114d. The column titles indicate the information associated with node 114 that is contained in the cell in that column. For example, the column labeled Ingress Interface indicates that the ingress interface for node 114d is air. As discussed above, each node 114 may add path information to a transmitted signal to enable intra-network switching, as illustrated in the column labeled Egress Label/Tag/Address. Accordingly, routing table 300 indicates that the signal transmitted from node 114i to node 114e includes the path node 114d to 114i to 114k to 114 f to 114k to 114i to 114e. Using this information, node 114c may modify the route for a message destined for mobile device 110b form the default node 114i to node 114d, as illustrated by signal stream 206 in FIG. 2. In short, including path information in a signal may enable intra-network switching.

Referring to FIG. 3B, connection table 350 includes information associated with the number of hops between nodes 114. Connection table 350 is arranged with three columns and five row sets. Each row set includes two or three associated rows. The intersection of one of these rows with one of the three columns forms a cell. Each cell contains information associated with a node 114 and/or the number of hops between nodes. In the illustrated embodiment, connection table 350 includes the following three columns: node, destination, and number of hops. Connection table 350 includes the following five row sets: D, I, K, F, and E. In other words, each row set is labeled with a letter indicating the associated node 114. For example, row set labeled D is associated with node 114d. As mentioned above, each row set includes two or three rows. The rows within a row set are associated with possible destinations of a message. For example, row set I is associated with node 114i, and each row within set I is associated with a possible destination node 114d, 114e, or 114k. Each cell in a row contains information associated with node 114. The column titles indicate the information associated with node 114 that is contained in the cell in that column. For example, the column labeled Number of Hops indicates that the number of hops between, for example, node 114i the destination node 114d, 114e, or 114k. As discussed above, each node 114 may use the number of hops between nodes to determine a route for a message. For example, node 114 may determine the route of a message based, at least in part, on the number of hops between nodes 114. Node 114 may include one or more of the following parameters when determining a route for a message: hop count, roundtrip time, estimation of bandwidth, and/or jitter calculations. In response to determining a route for a message, node 114 may update an associated routing table such as routing table 300.

FIG. 4 is a block diagram illustrating updating location information of mobile device 110b in response to at least mobile device 110b moving form node 114a to node FIG. 1 are shown. In the illustrated embodiment, mobile device 110a access network 112 through node 114d. Initially, both mobile devices 110b and 110c access network 112 through node 114a. Mobile device 110b, after a period of time, moves proximate node 114g and begins accessing network 112 through node 114g. In response to at least the handoff of device 110b to node 114g, routing tables 402 may be updated with new location information. In general, routing tables 402 are illustrated for each node 114 indicating location data for some mobile devices 110 in system 100. Routing tables 402 may be dynamic enabling routing tables 402 to be updated in response to at least receiving updated location information of mobile device 110. As a result, system 100 may be able to provide or maintain intra-network switching as mobile devices 110 move between nodes 114.

In one aspect of operation, mobile device 110a wirelessly transmits to node 114d a request to initiate a call with mobile device 110b. In some embodiments, node 114d receives a UMTS message and generates a UMA message based, at least in part, on the UMTS message. In the event that node 114d does not contain information identifying the location of mobile device 110b, node 114d forwards the signal to node 114i. In some embodiments, node 114d also modifies the signal to include information identifying that the signal was routed through node 114d. In the event that node 114i does not contain information identifying the location of mobile device 110c, node 114i, by default, forwards the signal to node 114k. As with node 114d, node 114i may also modify the signal to include path information indicating that the signal was routed from 114d to 114i. Similarly, nodes 114k and nodes 114f may modify with path information indicating the route of the signal. Node 114f forwards the signal to UNC 116 in the event that node 114f does not include location information for mobile device 110b. UNC 116 identifies the location of mobile device 110b and directs the signal to node 114f, which then directs the signal to node 114k then to node 114g. As the signal is routed through network 112, routing tables 402 may be updated to indicate that mobile device 110a is located at node 114d and mobile device 110b is located at node 114a based, at least in part, on the path information included in the signal. For example, node 114a may update the associated routing table 402a indicating that messages destined for device 110a be routed to directly to device 110a, not the default node 114i. As with the initial signal, the response form mobile device 110b may include locating information of mobile device 110b, and, thus node 114a may update routing table 402a indicating that messages destined for mobile device 110b be directly routed to mobile device b, not default node 114i. In the event that mobile device 110b moves in proximity to node 114g such that mobile device 110b access network 112 through node 114g, system 110 may update routing tables 402 based, at least in part, on the updated location information of mobile device 110b. System 100 may use any suitable technique for updating routing tables 402.

For example, UNC 116 may update routing tables 402 based, at least in part, on a list of the parties that communicated with mobile device 110b prior to the move. In this example, mobile device 110b may transmit a registration request to UNC 116 through network 112 via node 114g indicating the updated location information. In response to at least the updated location information, UNC 116 may retrieve a list of parties that communicated with mobile device 110b from HLR in the mobile core network. After retrieving the called parties information, UNC 116 may then transmit messages to nodes 114d, 114a, 114i, and 114k indicating that either their associated routing tables 402 may be updated using the updated path information or merely delete the location information of mobile device 110b. In the event of deletion, system 100 may update the routing tables 402 in response to at least a call session being established between mobile device 110a and 110b.

In another example, system 100 may use a buddy list to update routing tables with updated path information of mobile device 110b. In this example, mobile device 110b may maintain a buddy list of devices 110 in network 112. In this case, mobile device 110b may transmit updated location information to the devices identified in the buddy list. Alternatively or in combination, mobile device 110b may transmit the buddy list to node 114f. After receiving the buddy list, node 114f may transmit the updated path information to the identified devices 110 such as mobile device 110a. The buddy list may be stored at node 114f as well or only. In this case, in response to receiving a registration request form mobile device 110b, node 114f may identify devices on the stored buddy list and transmit the updated location information to the identified devices.

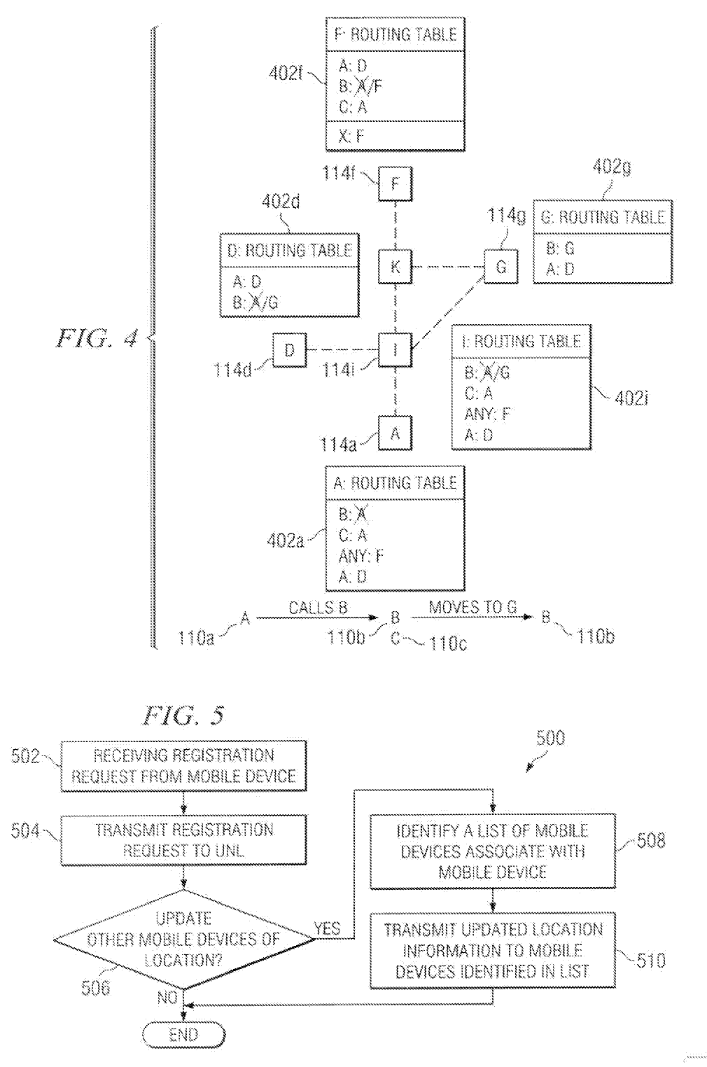

FIGS. 5, 6 and 7 are flow diagrams illustrating example method 200 for using updating routing tables in response to at least the mobility of mobile device 110b. Methods 500, 600, and 700 are described with respect to system 100 of FIG. 4, but methods 500, 600, and 700 could be used by any other application or applications. Moreover, system 100 may use any other suitable techniques for performing these tasks. Thus, many of the steps in this flowchart may take place simultaneously and/or in different orders as shown. System 100 may also use methods with additional steps, fewer steps, and/or different steps, so long as the methods remain appropriate.

Referring to FIG. 5, method 500 is describe with respect to node 114f of FIG. 4. Method 500 begins at step 502 where node 114f receives a request to register mobile device 110bvia node 114g. In response to at least the request, node 114f transmits the registration request to UNC 116 at step 504. If other mobiles devices 110 will not be updated with updated location information at decisional step 506, then execution ends. Otherwise, node 114f identifies a buddy list identifying a list of associated mobile devices 110 at step 508. Next, at step 510, updated location information may be transmitted to mobile devices 110 identified in the buddy list. As discussed above, messages transmitted thorough nodes 114 may be updated to include path information. As the updated location information is transmitted through network 112, nodes 114 may identify the path information included in the message and update routing tables 402 accordingly.

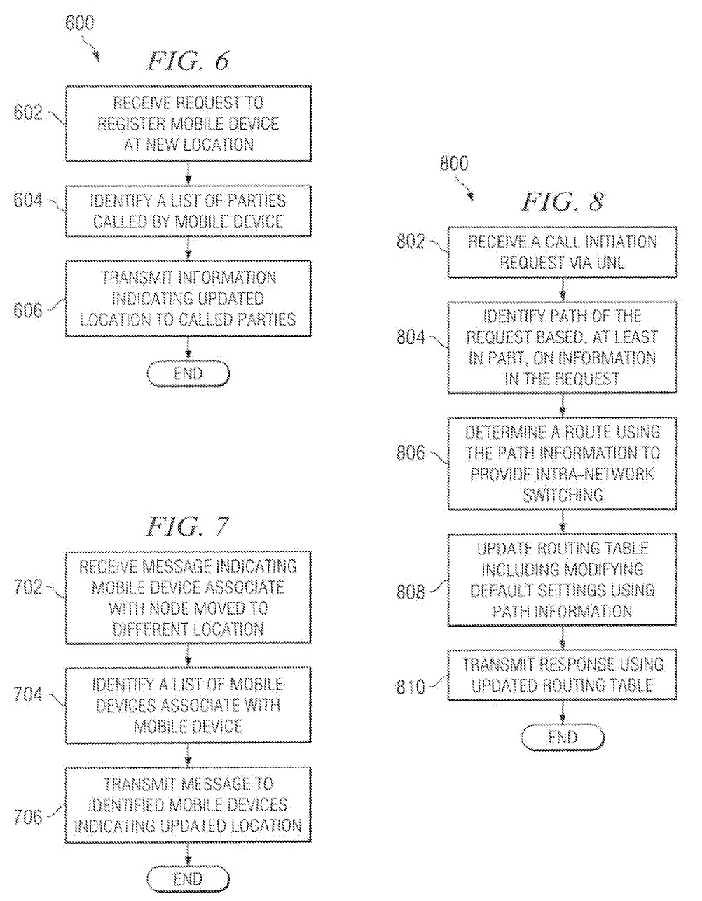

Referring to FIG. 6, method 600 is describe with respect to UNC 116 of FIG. 4. Method 600 begins at step 602 where UNC 116 receives a request to register device 110b at node 114g. In response to at least the registration request, UNC 116 identifies a list of mobile devices 110 in communication with mobile device 110b. In some embodiments, UNC 116 retrieves this information from HLR. After receiving the identified of these mobile devices 110, UNC 116 transmits information indicating the updated location information of mobile device 110b. As discussed above, messages transmitted through nodes 114 may be updated to include path information. As the updated location information is transmitted through network 112, nodes 114 may identify the path information included in the message and update routing tables 402 accordingly.

Referring to FIG. 7, method 700 is described with respect to node 114a. Method 700 begins at step 702 where node 114a receives a message indicating that mobile device 110b has moved to node 114g. In response to at least the message, node 114a identifies a list of devices 110 associated with mobile device 110b at step 704, Node 114a transmits a message indicating the updated location information to the associated mobile devices. As discussed above, messages transmitted through nodes 114 may be updated to include path information. As the updated location information is transmitted through network 112, nodes 114 may identify the path information included in the message and update routing tables 402 accordingly.

FIG. 8 is a flow diagram illustrating example method 800 for providing intra-network switching. Method 800 is described with respect to node 114e of FIG. 1, but method 800 could be used by any other application or applications. Moreover, node 114e may use any other suitable techniques for performing these tasks. Thus, many of the steps in this flowchart may take place simultaneously and/or in different orders as shown. Further, node 114e may execute logic implementing techniques similar to one or both of method 800 in parallel or in sequence. Node 114e may also use methods with additional steps, fewer steps, and/or different steps, so long as the methods remain appropriate.

Method 800 begins at step 802 where node 114e receives an call invitation request from mobile device 110d via UNC 116. In response to receiving the message, node 114e identifies path information included in the request. For example, the message may indicate that the path of the message is node 114a to 114i to 114k to 114f to 114k to 114i to 114e. Next, at step 806, node 114e determines a route to mobile device 110d based, at least in part, on the path information. For example, node 114e may update the associated routing table indicating that message destined for mobile device 110d be routed to node 114a. At step 810, node 114e routes a response to the call invitation directly to node 114a independent of UNC 116 using the updated routing table.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A method, comprising:
identifying a destination of a message based on a cellular radio technology, a call session comprising the message; and
providing intra-network switching of the message independent of a network element managing the call session.

2. The method of claim 1, further comprising identifying at least a portion of a route of the call session based, at least in part, on the message, the route identifying a network in a same network hierarchy.

3. A method comprising:
receiving a message destined for a mobile device based, at least in part, on cellular radio technology, the message identifying at least a portion of a route of the message;
identifying a first egress node and a second egress node based, at least in part, on the at least the portion of the route, the first egress node preceding the second egress node in the route; and
directly routing the message to the second egress node to eliminate the first egress node form the route of the message.

4. The method of claim 3, the message destined for a mobile device, further comprising updating a routing table associated with the mobile device to eliminate the first egress node for additional messages destined for the mobile device.

5. A method, comprising:
receiving a communication in an Internet Protocol network, the communication based, at least in part, on a cellular radio technology associated with a mobile switching center; and
routing the communication to a network element independent of the mobile switching center.

6. The method of claim 5, the communication including path information identifying a plurality of network elements that the communication was routed through, further comprising modifying the path information indicating that the communication was routed through an associated network element in addition to the plurality of elements.

7. The method of claim 5, wherein the communication comprises a first communication, further comprising:
receiving a second communication destined for a mobile device, the second communication including path information identifying a plurality of network elements that the second communication was routed through; and
routing the first communication based, at least in part, on the path information.

8. The method of claim 7, further comprising:
determining at least a portion of the route to the mobile device based, at least in part, on the path information; and
updating a routing table in accordance with the determined route independent of the mobile switching center.

9. The method of claim 7, wherein the mobile device transmits Universal Mobile Telecommunications System (UMTS) signals.

10. The method of claim 5, the communication comprising a first communication and destined for a mobile device, further comprising:
receiving a second communication including information indicating an updated location of the mobile device, the second communication including updated path information identifying a plurality of network elements that the second communication was routed through; and
updating an associated routed table based, at least in part, on the updated path information.

11. The method of claim 5, wherein the radio cellular technology comprises Global System for Mobile Communication (GSM).

12. The method of claim 5, wherein the radio cellular technology comprises Code Division Multiple Access (CDMA).

13. A method, comprising:
receiving a communication destined for a mobile device, the communication including path information identifying a plurality of network elements that the communication was routed through; and
modifying the path information to indicate that the communication was routed through an associated network element in addition to the plurality of elements.

14. The method of claim 13, further comprising:
identifying a transmitting device based, at least in part on the communication; and
determining at least a portion of a route to the transmitting device based, at least in part, on the path information.

15. The method of claim 14, further comprising:
receiving a response to the transmitting device form the mobile device; and
routing the response based, at least in part, on the at least the portion of the route independent of a mobile switching center.

16. A method, comprising:
representing to a UNC a wireline device as a mobile device, the UNC operable to store location information associated with the wireline device based, at least in part, on the representation; and
providing intra-network switching for the wireline device based, at least in part, on the location information.

17. The method of claim 16, further comprising:
receiving a message from the wireline device; and
updating the message with information identifying a route of the message.

18. A method, comprising:
receiving a message destined for a mobile device, the message identifying location information associated with an origination device; and
updating the message with information identifying a network node that the message was routed through.

19. The method of claim 18, further comprising:
receiving a response form the mobile device, the response identifying location information associated with the mobile device; and
updating an associated routing table with the location information associated with the mobile device to provide intra-network switching for messages destined for the mobile device.

20. A data signal embodied in a carrier wave comprising:
a first segment comprising information identifying an address of a destination mobile device;
a second segment comprising information identifying an address of a transmitting mobile device; and
a third segment comprising information identifying a plurality of network elements that the data signal was routed through.

21. The data signal embodied in the carrier wave of claim 20, wherein the plurality of network elements are operable to provide intra-network switching.

22. A system for providing a development environment, comprising:
memory operable to store routing information; and
one or more processors operable to:
receive a communication in an Internet Protocol network, the communication based, at least in part, on a cellular radio technology associated with a mobile switching center; and
route the communication to a network element independent of the mobile switching center.

23. The system of claim 22, the communication including path information identifying a plurality of network elements that the communication was routed through, the processors further operable to modify the path information indicating that the communication was routed through an associated network element in addition to the plurality of elements.

24. The system of claim 23, the communication comprises a first communication, the processors further operable to:
receive a second communication destined for a mobile device, the communication including path information identifying a plurality of network elements that the communication was routed through; and
route the first communication based, at least in part, on the path information.

25. The system of claim 24, the processors further operable to:
determine at least a portion of the route to the mobile device based, at least in part, on the path information; and
update a routing table in accordance with the determined route independent of the mobile switching center.

26. The system of claim 22, the communication comprising a first communication and destined for a mobile device, the processors further operable to:
receive a second communication including information indicating an updated location of the mobile device, the second communication including updated path information indicating identifying a plurality of network elements that the second communication was routed through including the updated location information; and
update an associated routing table based, at least in part, on the updated path information.

27. A system, comprising:
memory operable to store routing information; and
one or more processors operable to:
receive a communication destined for a mobile device, the second communication including path information identifying a plurality of network elements that the second communication was routed through; and
modify the path information to indicate that the communication was routed through an associated network element in addition to the plurality of elements.

28. The system of claim 27, the processors further operable to:
identify a transmitting device based, at least in part on the communication; and
determine at least a portion of a route to the transmitting device based, at least in part, on the path information.

29. The system of claim 28, the processors further operable to:
receive a response to the transmitting device from the mobile device; and
route the response based, at least in part, on the determined route independent of a mobile switching center.
